(19) United States
(12) Patent Application Publication
(10) Pub. No.: US 2020/0356330 A1
(43) Pub. Date: Nov. 12, 2020

(54) IMAGE FORMING APPARATUS, NON-TRANSITORY COMPUTER READABLE MEDIUM, AND IMAGE FORMING SYSTEM

(71) Applicant: FUJI XEROX CO., LTD., Tokyo (JP)

(72) Inventor: Daigo YAMAGISHI, Kanagawa (JP)

(73) Assignee: FUJI XEROX CO., LTD., Tokyo (JP)

(21) Appl. No.: 16/599,628

(22) Filed: Oct. 11, 2019

(30) Foreign Application Priority Data
May 7, 2019 (JP) 2019-087794

(51) Int. Cl. G06F 3/12

(52) U.S. Cl. CPC G06F 3/1292; G06F 3/1274; G06F 3/1238

(57) ABSTRACT

An image forming apparatus includes a printing unit that performs printing using print data, a wireless communication unit that transmits and receives a wireless signal based on radio waves or space lighting to and from a mobile terminal associated with a user, a login management unit that manages a state of first login by the user in accordance with a received strength of a wireless signal received by the wireless communication unit or a physical quantity that correlates with the received strength, and a printing control unit that instructs the printing unit to perform printing using the print data specified by the user and, if the image forming apparatus receives a printing execution notification indicating that another image forming apparatus is to perform printing specified by the user, forbids an instruction for printing corresponding to the printing execution notification or cancels an instruction for printing that has already been issued.

### CROSS-REFERENCE TO RELATED APPLICATIONS

This application is based on and claims priority under 35 USC 119 from Japanese Patent Application No. 2019-087794 filed May 7, 2019.

### Background

### (i) Technical Field

The present disclosure relates to an image forming apparatus, a non-transitory computer readable medium, and an image forming system.

### (ii) Related Art

Japanese Unexamined Patent Application Publication No. 2008-200898 discloses an apparatus that authenticates a user if a user identifier (ID) obtained from an external terminal through short-range communication and a user ID registered therein match. In this example of the related art, printing is requested by selecting, using keys, a job on a job list displayed on the external terminal.

Japanese Unexamined Patent Application Publication No. 2017-167685 discloses an apparatus that receives a first printing instruction from a user, reserves the first printing instruction while associating the first printing instruction with the user, and, if a second printing instruction is issued after the user is authenticated retrospectively, automatically issues the reserved first printing instruction. In this example of the related art, the second printing instruction is, for example, an instruction given by the user through a mobile terminal, a certain gesture, a certain sound, or transmission of data indicating permission of automatic execution.

### SUMMARY

Time and effort of a user might be further reduced by managing login by the user and requesting printing using the received strength of wireless signals successively output from a mobile terminal. When a time pattern of received strength indicating that the user is waiting in front of an image forming apparatus has been detected, for example, the image forming apparatus may start printing.

When a plurality of image forming apparatuses are provided close to one another, however, the plurality of image forming apparatus might simultaneously detect similar time patterns of signal strength from a single mobile terminal. That is, if a relationship between the plurality of image forming apparatuses is not taken into consideration, the plurality of image forming apparatuses might simultaneously output the same print in accordance with login and a request of printing by the user. As a result, resources might be wasted by the redundant printing and inconvenience in information control due to leftover prints might be caused.

Aspects of non-limiting embodiments of the present disclosure relate to suppression of simultaneous printing of the same print by a plurality of image forming apparatuses provided close to one another when login is managed and printing is requested using the received strength of wireless signals successively output from a mobile terminal, compared to when a relationship between the plurality of image forming apparatuses is not taken into consideration.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an image forming apparatus including a printing unit that performs printing using print data, a wireless communication unit that transmits and receives a wireless signal based on radio waves or space lighting to and from a mobile terminal associated with a user, a login management unit that manages a state of first login by the user in accordance with a received strength of a wireless signal received by the wireless communication unit or a physical quantity that correlates with the received strength, and a printing control unit that, if a time series of the received strength or a time series of the physical quantity satisfies a predetermined condition during the first login by the user, instructs the printing unit to perform printing using the print data specified by the user and, if the image forming apparatus receives a printing execution notification indicating that another image forming apparatus is to perform printing specified by the user, forbids an instruction for printing corresponding to the printing execution notification or cancels an instruction for printing that has already been issued.

### BRIEF DESCRIPTION OF THE DRAWINGS

An exemplary embodiment of the present disclosure will be described in detail based on the following figures, wherein:

FIG. 1 is a diagram illustrating the overall configuration of an image forming system into which image forming apparatuses are incorporated according to an exemplary embodiment of the present disclosure;

FIG. 2 is an electrical block diagram illustrating one of the image forming apparatuses illustrated in FIG. 1;

FIG. 3 is a functional block diagram illustrating a controller illustrated in FIG. 2;

FIG. 4A is a diagram illustrating an example of the data structure of a login management table illustrated in FIG. 3, and FIG. 4B is a diagram illustrating an example of the data structure of a print job queue illustrated in FIG. 3;

FIG. 5 is a plan view schematically illustrating a relative positional relationship between image forming apparatuses and a mobile terminal in an installation area;

FIG. 6A is a graph indicating temporal changes in distances between the image forming apparatuses and the mobile terminal, and FIG. 6B is a graph indicating temporal changes in the received strength of wireless signals output from the mobile terminal;

FIG. 7 is a first flowchart illustrating an anywhere printing operation performed by one of the image forming apparatuses;

FIG. 8 is a second flowchart illustrating the anywhere printing operation performed by the image forming apparatus;

FIG. 9 is a diagram illustrating an effect produced by informing a user that the anywhere printing operation is forbidden;

FIGS. 10A and 10B are diagrams illustrating a first example of a time pattern of received strength;

FIGS. 11A and 11B are diagrams illustrating a second example of the time pattern of received strength;

FIGS. 12A and 12B are diagrams illustrating a third example of the time pattern of received strength; and

FIG. 13 is a diagram illustrating an effect produced by a printing execution notification.

### DETAILED DESCRIPTION

An exemplary embodiment will be described with reference to the accompanying drawings for an image forming apparatus in the present disclosure in relation to an image forming system and a non-transitory computer readable medium. It is needless to say that the present disclosure is not limited to the following exemplary embodiment and may be freely modified without deviating from the scope of the present disclosure. Alternatively, components may be combined together insofar as no technical contradictions are caused.

### Configuration of Image Forming Apparatuses 12

### Overall Configuration of Image Forming System 10

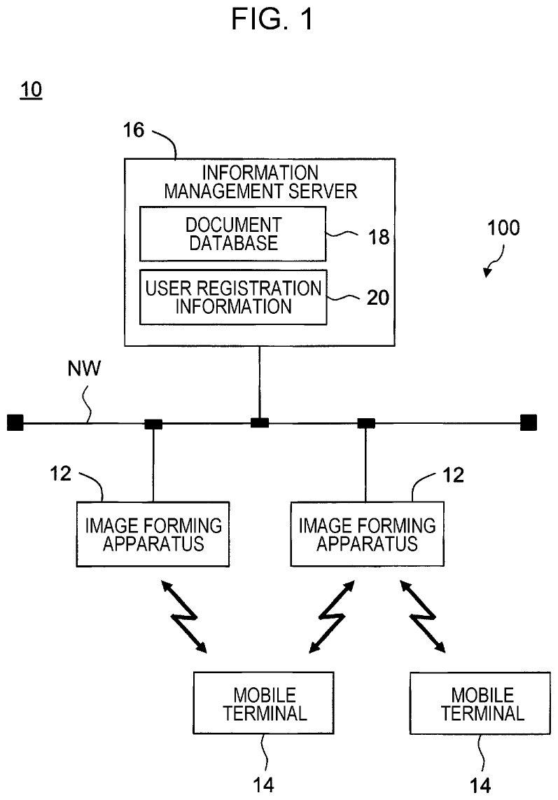

FIG. 1 is a diagram illustrating the overall configuration of an image forming system 10 into which image forming apparatuses 12 are incorporated according to the exemplary embodiment of the present disclosure. The image forming system 10 is a system configured to be able to provide an image forming service, which provides, for a user within an installation area 100, objects on which images are formed.

The image forming system 10 includes one or more image forming apparatus 12, one or more mobile terminals 14, and an information management server 16. In the example illustrated in FIG. 1, two image forming apparatuses 12 and one information management server 16 are connected to each other through a short-range network NW constructed in the installation area 100.

The image forming apparatuses 12 are digital multifunction peripherals (MFPs) that execute at least a print function, a copy function, a scan function, a facsimile function, or a data transmission function.

The mobile terminals 14 are portable multifunction and multipurpose devices configured to be able to wirelessly communicate with the image forming apparatuses 12. The mobile terminals 14 are, for example, tablets, smartphones, or wearable computers. The users can use an “anywhere printing service”, which achieves on-demand printing at various positions within the installation area 100, by operating the mobile terminals 14.

The information management server 16 may store information (e.g., user information, security information, and data management information) necessary to manage the image forming apparatuses 12 and provide the information at appropriate timings in response to requests from the image forming apparatuses 12. In the example illustrated in FIG. 1, a document database 18 and user registration information 20 are stored in the information management server 16 in the example illustrated in FIG. 1.

### Configuration of Image Forming Apparatuses 12

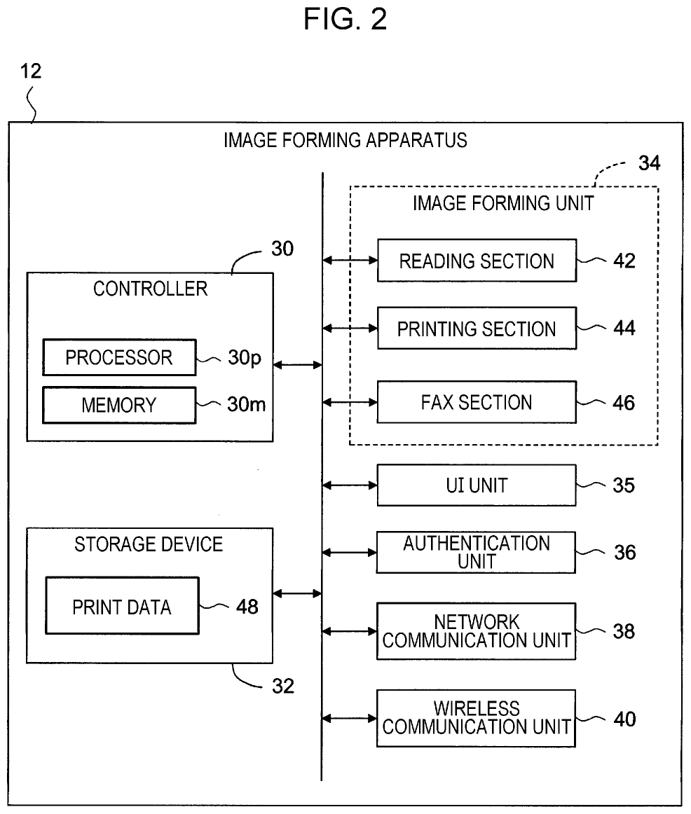

FIG. 2 is an electrical block diagram illustrating one of the image forming apparatuses 12 illustrated in FIG. 1. The image forming apparatus 12 includes a controller 30, a storage device 32, an image forming unit 34, a user interface (UI) unit 35, an authentication unit 36, a network communication unit 38, and a wireless communication unit 40.

The image forming unit 34 includes a reading section 42 that reads a sheet and generates image data, a printing section 44 (corresponds to a “printing unit”) that outputs a print on the basis of the image data, and a fax section 46 that performs facsimile. The UI unit 35 is achieved by a touch panel display and hardware buttons and receives inputs from the user. The authentication unit 36 uses one of various authentication methods, such as password authentication, card authentication, and biometric authentication, to authenticate a user authorized to use the service.

The network communication unit 38 is a communication module for performing network communication with external apparatuses including the information management server 16. The wireless communication unit 40 is a communication module for performing wireless communication with external apparatuses including the mobile terminals 14. “Wireless communication” herein refers to not only wireless communication in a narrow sense that employs radio waves but also free-space optical communication (more specifically, infrared communication or visible light communication) that employs space lighting. Bluetooth Low Energy (BLE), for example, may be used as a standard for wireless communication.

The controller 30 includes a processor 30p and a memory 30m and controls the components of the image forming apparatus 12. The processor 30p is a processing device including a central processing unit (CPU) or a microprocessing unit (MPU). The memory 30m is a non-transitory computer readable storage medium.

The storage device 32 is achieved by a hard disk drive (HDD) or a solid-state drive (SSD), for example, and stores various pieces of data handled by the image forming apparatus 12. In the example illustrated in FIG. 2, the storage device 32 stores print data 48 obtained from a document database 18 (FIG. 1).

### Functional Block Diagram Illustrating Controller 30

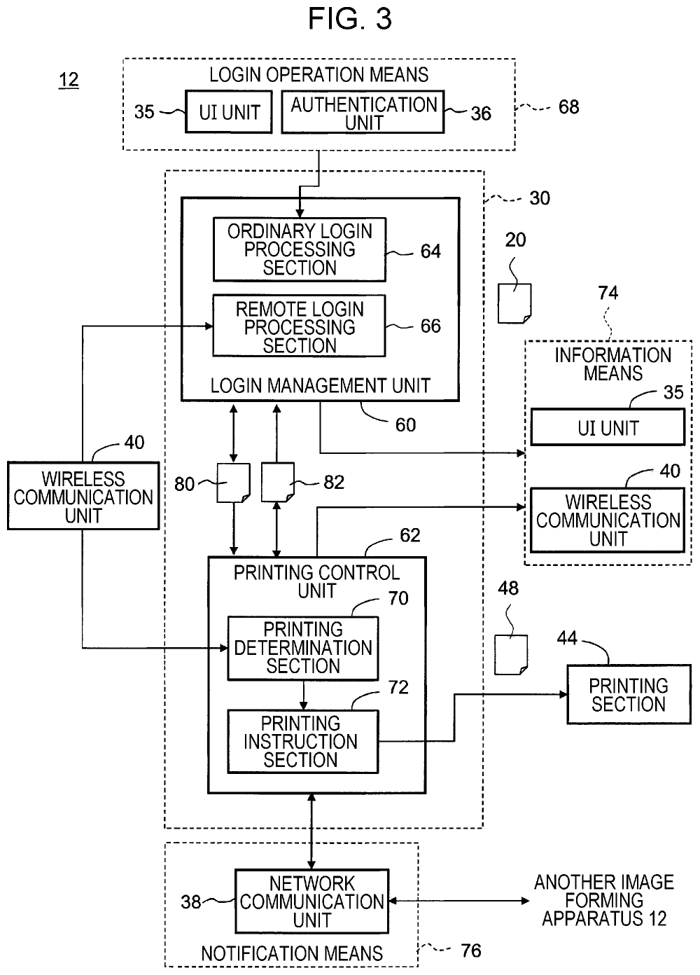

FIG. 3 is a functional block diagram illustrating the controller 30 illustrated in FIG. 2. The processor 30p of the controller 30 functions as a login management unit 60 and a printing control unit 62 by reading a program relating to the image forming service from the memory 30m and executing the program.

The login management unit 60 manages a login state of a user who is trying to use the image forming service. More specifically, the login management unit 60 includes an ordinary login processing section 64 that manages ordinary login (corresponds to “second login”) and a remote login processing section 66 that manages remote login (corresponds to “first login”). “Ordinary login” herein refers to manual login achieved using a login operation unit 68 (a user interface (UI) unit 35 or an authentication unit 36) provided for the image forming apparatus 12. “Remote login”, on the other hand, refers to automatic login achieved using a wireless signal received by the wireless communication unit 40.

The printing control unit 62 performs printing control including execution of print jobs. The printing control unit 62 includes a printing determination section 70 that determines whether to perform printing and a printing instruction section 72 that instructs the printing section 44 to perform or stop printing.

Information means 74 is configured to be able to transmit information to the outside in accordance with an instruction from the login management unit 60 or the printing control unit 62. When information is transmitted to a user located close to the image forming apparatus 12, for example, the UI unit 35 functions as the information means 74. When information is transmitted to a user who carries one of the mobile terminals 14, the wireless communication unit 40 functions as the information means 74.

The notification means 76 transmit a printing execution notification, which will be described later, to another image forming apparatus 12 in accordance with an instruction from the printing control unit 62. The notification means 76 also receives a printing execution notification from another image forming apparatus 12. Here, a network communication unit 38 corresponds to the notification means 76.

The login management unit 60 is configured to be able to update a login management table 80 and read a print job queue 82. The printing control unit 62 is also configured to be able to read the login management table 80 and update the print job queue 82.

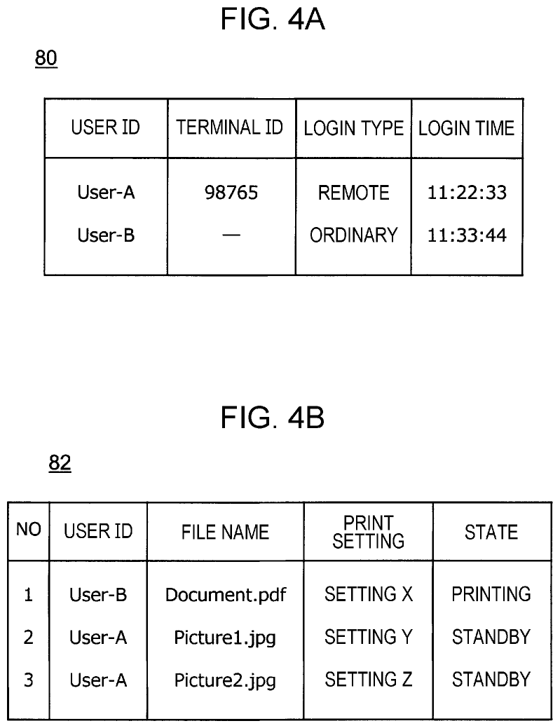

FIG. 4A is a diagram illustrating an example of the data structure of the login management table 80 illustrated in FIG. 3. The login management table 80 is data in a table format indicating correspondences between user IDs, which indicate identification information regarding the users, terminal IDs, which indicate identification information regarding the mobile terminals 14, login types, and login times. A terminal ID is written to the login management table 80 only in the case of remote login, which involves a mobile terminal 14.

FIG. 4B is a diagram illustrating an example of the data structure of the print job queue 82 illustrated in FIG. 3. The print job queue 82 is data in a list format in which a user ID, a file name, a print setting, and a state are enumerated for each queue number. The print setting includes, for example, a plurality of setting items such as the number of copies to be printed, specification of color/black-and-white printing, specification of double-sided/single-sided printing, sheet size, N-up, and an enlargement/reduction percentage. The state of each process is classified into, for example, printing, standby, or stopped.

### Operation of Image Forming Apparatus 12

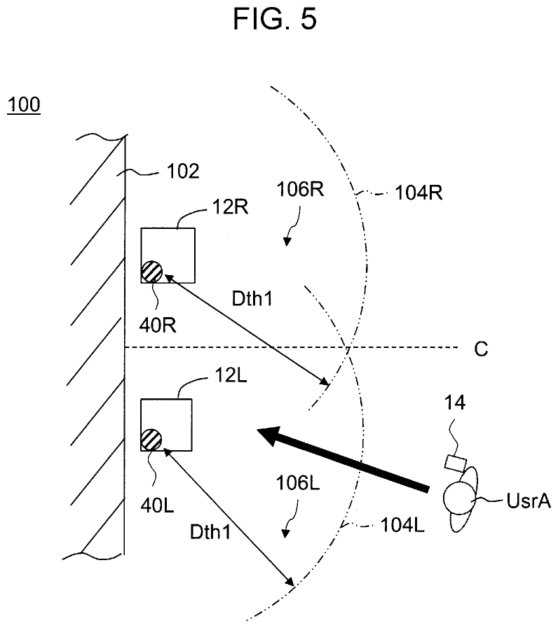

The image forming apparatus 12 according to the present exemplary embodiment is configured as described above. Next, the operation of the image forming apparatus 12 (more specifically, an “anywhere printing operation”) will be described with reference to FIGS. 5 to 13.

### Assumed Scene

FIG. 5 is a plan view schematically illustrating a relative positional relationship between image forming apparatuses 12R and 12L and a mobile terminal 14 in the installation area 100. The two image forming apparatuses 12R and 12L are provided in the installation area 100 along a wall 102. An apparatus on the right as a user UsrA faces the wall 102 will be referred to as an “image forming apparatus 12R”, and an apparatus on the left as the user UsrA faces the wall 102 will be referred to as an “image forming apparatus 12L” hereinafter. It is assumed that the user UsrA who can use the anywhere printing service walks toward the nearest image forming apparatus 12L while operating the mobile terminal 14 carried thereby.

A first boundary line 104R having a shape of a substantially circular arc indicates a locus of positions whose distances from a wireless communication unit 40R provided for the image forming apparatus 12R are Dth1 (hereinafter referred to as a “login permission distance”). An area defined by the first boundary line 104R corresponds to a login permission area 106R, in which the image forming apparatus 12R permits the user UsrA to perform remote login. Similarly, a first boundary line 104L having a shape of a substantially circular arc indicates a locus of positions whose distances from a wireless communication unit 40L provided for the image forming apparatus 12L are Dth1. An area defined by the first boundary line 104L corresponds to a login permission area 106L, in which the image forming apparatus 12L permits the user UsrA to perform remote login.

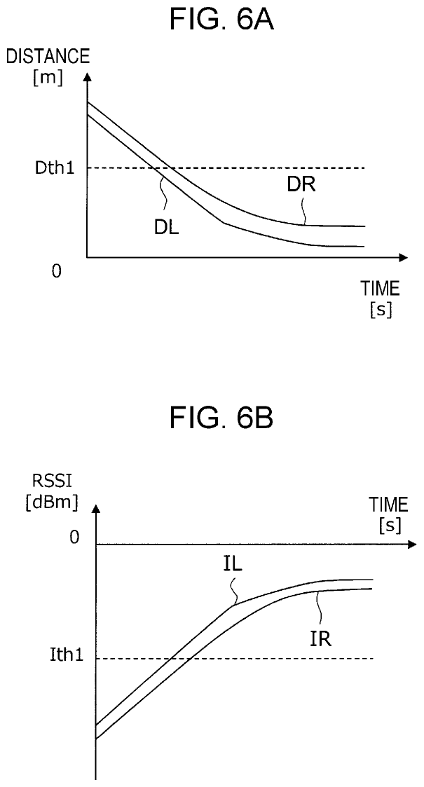

FIG. 6A is a graph indicating temporal changes in distances between the image forming apparatuses 12R and 12L and the mobile terminal 14. A horizontal axis of the graph represents time (unit: s), and a vertical axis of the graph represents distance (unit: m). The distance from the right image forming apparatus 12R is denoted by DR, and the distance from the left image forming apparatus 12L is denoted by DL. In the example illustrated in FIG. 5, the user UsrA accesses the image forming apparatus 12L from the left of a central line C against the wall 102 (a lower part of FIG. 5), and the distances DR and DL decrease over time while maintaining a relationship of DR>DL.

FIG. 6B is a graph indicating temporal changes in the received strength of wireless signals output from the mobile terminal 14. A horizontal axis of the graph represents time (unit: s), and a vertical axis of the graph represents a received signal strength indicator (RSSI; unit: dBm). The RSSI is a common logarithm of received strength and defined in such a way as to be zero [dBm] with a reference distance (e.g., zero [m]).

A received strength obtained by the right image forming apparatus 12R is denoted by IR, and a received strength obtained by the left image forming apparatus 12L is denoted by IL herein. In the example illustrated in FIG. 5, the user UsrA accesses the image forming apparatus 12L from the left of the central line C against the wall 102 (the lower part of FIG. 5), and the received strengths IR and IL increase over time while maintaining a relationship of IR<IL.

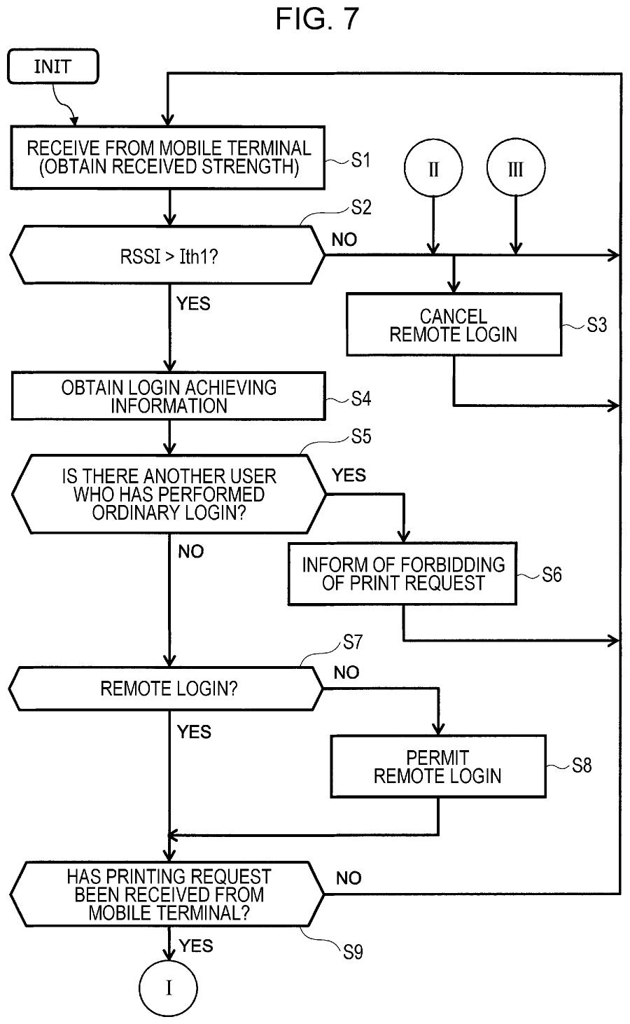

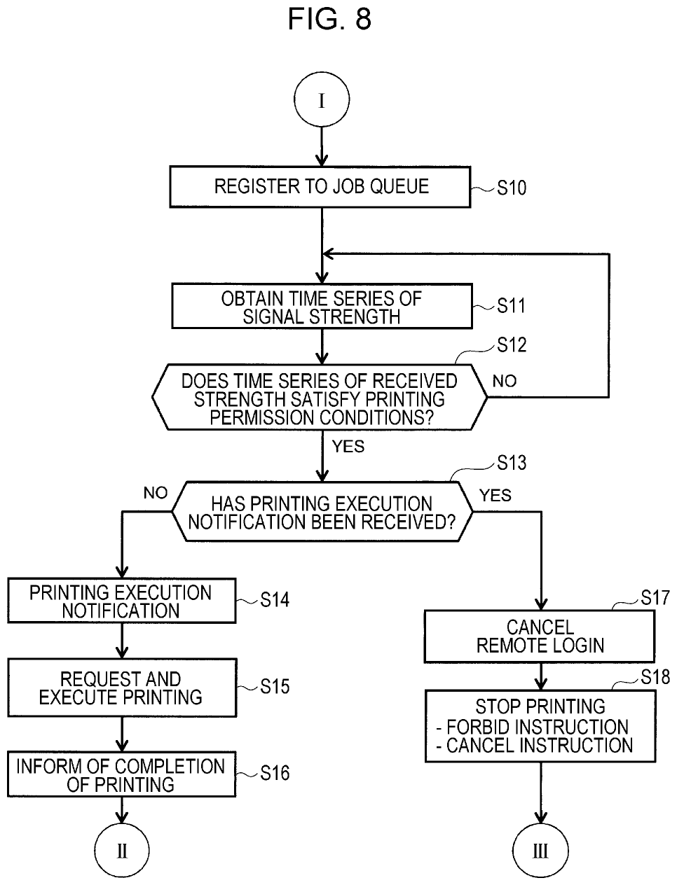

In consideration of the above technical features, a method for controlling printing for saving time and effort of the user UsrA by managing login and requesting printing using the received strength of wireless signals will be proposed. The anywhere printing operation of the image forming apparatus 12 will be described hereinafter with reference to flowcharts of FIGS. 7 and 8.

### Operation

In step S1 illustrated in FIG. 7, the wireless communication unit 40 receives a wireless signal from a mobile terminal 14. The login management unit 60 (more specifically, the remote login processing section 66) obtains the received strength of the received wireless signal. The received strength may be a continuous value such as the RSSI or a discrete value such as an incremental strength level. In the following description, the RSSI will be taken as an example.

The remote login processing section 66 may obtain a physical quantity that correlates with the received strength (e.g., a distance or proximity to the mobile terminal 14) instead of the received strength. The distance is calculated, for example, using the received strength and the reference distance in accordance with the Friis transmission equation. Because there is a negative correlation between the received strength and the distance, a relationship with a threshold is reversed when a threshold determination, which will be described later, is made using the distance.

In step S2, the remote login processing section 66 compares the received strength obtained in step S1 and a predetermined threshold Ith1 (corresponds to a “first threshold”). The threshold Ith1 is a signal strength corresponding to the login permission distance Dth1 illustrated in FIG. 5. If RSSI>Ith1 is not satisfied, that is, if RSSI≤Ith1 (NO in step S2), the process returns to step S1 in the case of logout and proceeds to step S3 in the case of login.

In step S3, if the user UsrA has performed remote login, the remote login processing section 66 removes login information (more specifically, a user ID, a terminal ID, a login type, and a login time) regarding the user UsrA from the current login management table 80 to cancel the remote login by the user UsrA. If the user UsrA reaches the first boundary line 104R or 104L and RSSI>Ith1 is satisfied (YES in step S2) after at least steps S1 and S2 are repeated, the process proceeds to step S4.

In step S4, the remote login processing section 66 establishes a connection with the mobile terminal 14 and obtains login achieving information from the mobile terminal 14 through the wireless communication unit 40. The login achieving information is information with which the user UsrA can be identified, and may be a user ID or a terminal ID.

In step S5, the login management unit 60 refers to the current login management table 80 and checks whether there is another user who has performed ordinary login. If not (NO in step S5), the process skips step S6 and proceeds to step S7. If so (YES in step S5), the process proceeds to step S6.

In step S6, the information means 74 receives an informing instruction from the login management unit 60 and informs the user UsrA that a printing request (the anywhere printing operation here) will not be accepted. When the information means 74 is the UI unit 35, for example, a warning message may be displayed on the display or a speaker may output a warning sound. When the information means 74 is the wireless communication unit 40, on the other hand, the wireless communication unit 40 may output a wireless signal including the informing instruction to the mobile terminal 14.

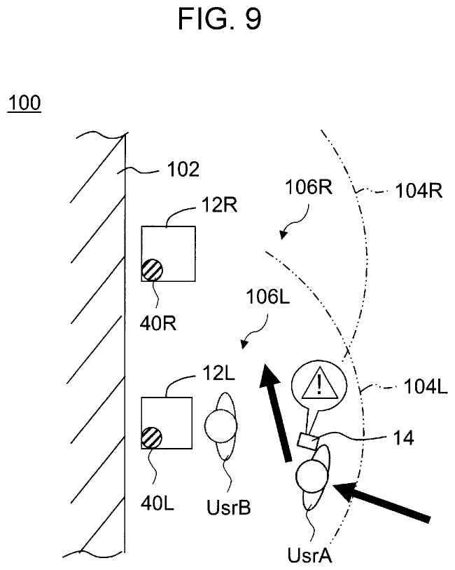

FIG. 9 is a diagram illustrating an effect produced by informing the user UsrA that the anywhere printing operation is forbidden. It is assumed in an example illustrated in FIG. 9 that another user UsrB performs an operation for performing ordinary login using the login operation unit 68 (FIG. 3) provided for the image forming apparatus 12L. When the user UsrA has passed through the first boundary line 104L and entered the login permission area 106L, the mobile terminal 14 of the user UsrA displays, for example, a message indicating that the anywhere printing operation is not available along with a device name of the image forming apparatus 12L.

The user UsrA understands from the message that the image forming apparatus 12L is not available. The user UsrA turns right and approaches the image forming apparatus 12R. As a result, the user UsrA passes through the first boundary line 104R and enters the login permission area 106R. The image forming apparatus 12R permits the user UsrA to perform remote login.

The login management unit 60 may thus manage a state of ordinary login in accordance with a user operation performed using the login operation unit 68 provided therefor and forbid the user UsrA from performing remote login during ordinary login by the user UsrB, who is different from the user UsrA. A print 120 is therefore not output from an image forming apparatus 12 that the user UsrB is likely to be using, and the security of information owned by the user UsrA tends to be secured compared to when the user UsrA is permitted to perform remote login during ordinary login by the user UsrB.

In addition, when forbidding the user UsrA from performing remote login, the wireless communication unit 40 may transmit, to the mobile terminal 14, a wireless signal for informing the user UsrA that a printing request will not be accepted. The user UsrA can thus be certainly informed, through the mobile terminal 14, that a printing request will not be accepted without being affected by presence of the user UsrB around the image forming apparatus 12, compared to when visual information is provided using display means provided for the image forming apparatus 12.

In step S7 illustrated in FIG. 7, the remote login processing section 66 compares the login achieving information obtained in step S4, the user registration information 20, and the login management table 80 with one another to check whether the user UsrA has performed remote login. If so (YES in step S7), the process skips step S8 and proceeds to step S9. If not (NO in step S7), the process proceeds to step S8.

In step S8, the remote login processing section 66 adds the login information (more specifically, the user ID, the terminal ID, the login type, and the login time) regarding the user UsrA to the current login management table 80 to permit the user UsrA to perform remote login. The login management unit 60 thus permits the user UsrA associated with the mobile terminal 14 to perform remote login if RSSI>Ith1 is satisfied.

In step S9, the printing control unit 62 (more specifically, the printing determination section 70) checks whether a printing request has been received from the user UsrA. The printing request may be issued, for example, using a wireless signal transmitted by the mobile terminal 14 in accordance with an operation (e.g., a tap operation) performed by the user UsrA. If a printing request has not been received from the user UsrA (NO in step S9), the process returns to step S1, and any of steps S1 to S8 is repeated until a printing request is received. If a printing request has been received from the user UsrA (YES in step S9), on the other hand, the process proceeds to step S10.

In step S10 illustrated in FIG. 8, the printing control unit 62 adds job information (more specifically, a user ID, a file name of print data 48, and a print setting) regarding the printing request received in step S7 to the print job queue 82 to register a print job specified by the user UsrA. The printing control unit 62 also refers to the document database 18 constructed in the information management server 16 and obtains print data 48 corresponding to the user UsrA or the mobile terminal 14.

In step S11, as in step S1, the printing determination section 70 obtains a time series of the signal strength of the wireless signal or a time series of the physical quantity.

In step S12, the printing determination section 70 determines whether the time series of the received strength or the time series of the physical quantity obtained in step S11 satisfies predetermined conditions (hereinafter referred to as “printing permission conditions”). The printing permission conditions are conditions for permitting the user UsrA to perform printing using the print data 48 insofar as the user UsrA has performed remote login.

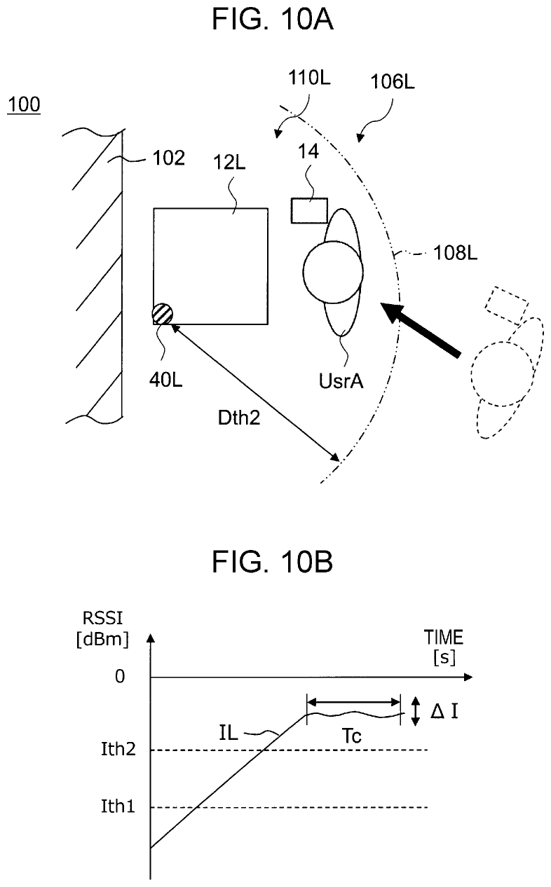

FIGS. 10A and 10B are diagrams illustrating a first example of a time pattern of received strength. More specifically, FIG. 10A is a plan view schematically illustrating behavior of the user UsrA who is approaching the image forming apparatus 12L. FIG. 10B is a diagram illustrating temporal changes in the received strength of the wireless signal corresponding to FIG. 10A. The user UsrA goes straight to the image forming apparatus 12L, which is a destination, at a substantially uniform velocity. The user UsrA then slows down and stops in front of the image forming apparatus 12L. The user UsrA waits in front of the image forming apparatus 12L until a start or an end of printing.

A second boundary line 108L having a shape of a substantially circular arc indicates a locus of positions whose distances from the wireless communication unit 40L provided for the image forming apparatus 12L are Dth2 (hereinafter referred to as a “printing permission distance”). An area defined by the second boundary line 108L corresponds to a printing permission area 110L, in which the image forming apparatus 12L permits printing. The printing permission distance Dth2 is set smaller than the login permission distance Dth1.

If the time pattern indicating the behavior of the user UsrA is detected, the printing determination section 70 determines whether the printing permission conditions are satisfied. The printing determination section 70 determines, for example, [Condition 1] whether RSSI>Ith2 is satisfied and [Condition 2] whether ΔI<ΔIth is maintained for longer than a period of time Tc. Here, the threshold Ith2 is a signal strength corresponding to the printing permission distance Dth2 illustrated in FIG. 10A and larger than Ith1 (corresponds to a “second threshold”). ΔI denotes the amount of temporal change in the RSSI. Specific examples of ΔI include a time derivative, a moving average of the time derivative, and a variation in a certain time period (a difference between a largest value and a smallest value). ΔIth is a threshold corresponding to a permissible margin of the amount ΔI of temporal change (corresponds to a “third threshold”).

If the printing permission conditions, namely Conditions 1 and 2, for example, are not simultaneously satisfied (NO in step S12), the process returns to step S11, and steps S11 and S12 are repeated until the printing permission conditions are satisfied. If Conditions 1 and 2 are simultaneously satisfied (YES in step S12), on the other hand, the process proceeds to step S13. If the printing permission conditions remain unsatisfied for longer than a predetermined time period, the login management unit 60 may cancel the remote login or the printing control unit 62 may stop printing.

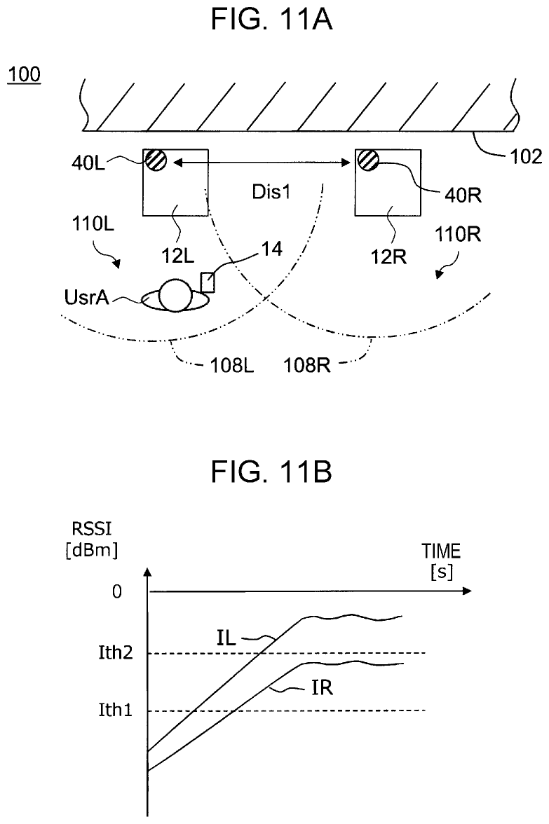

FIGS. 11A and 11B are diagrams illustrating a second example of the time pattern of received strength. More specifically, FIG. 11A is a plan view schematically illustrating installation states of the two image forming apparatuses 12R and 12L. FIG. 11B is a diagram illustrating temporal changes in the received strength of wireless signals at a time when the user UsrA is approaching the left image forming apparatus 12L.

As illustrated in FIG. 11A, when a distance between feature points (e.g., positions of the wireless communication units 40) of the two image forming apparatuses 12R and 12L is denoted by Dis1, Dis1>Dth2. In this case, while the user UsrA is waiting in front of the image forming apparatus 12L, the mobile terminal 14 is located inside the printing permission area 110L but outside a printing permission area 110R.

As a result, as illustrated in FIG. 11B, RSSI>Ith2>Ith1 for a left received strength IL while the user UsrA is waiting, and the printing permission conditions for the image forming apparatus 12L are satisfied. Meanwhile, Ith1<RSSI<Ith2 for a right received strength IR, and the printing permission conditions for the image forming apparatus 12R are not satisfied. That is, although the two image forming apparatuses 12R and 12L simultaneously permit the user UsrA to perform remote login, only the image forming apparatus 12L achieves printing.

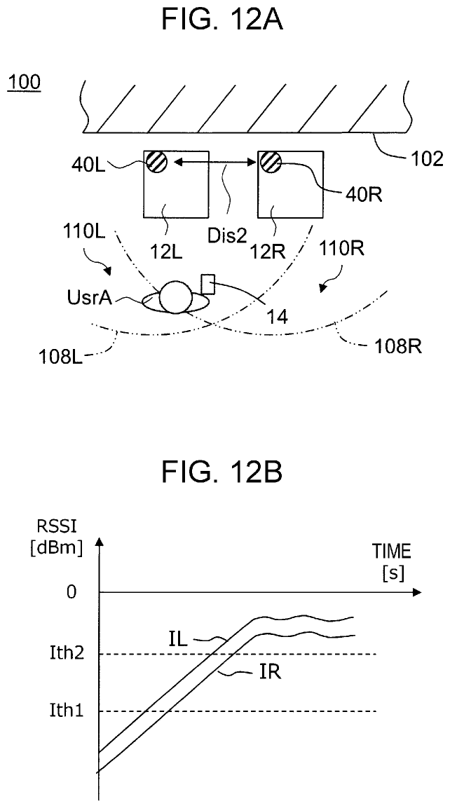

FIGS. 12A and 12B are diagrams illustrating a third example of the time pattern of received strength. More specifically, FIG. 12A is a plan view schematically illustrating the installation states of the two image forming apparatuses 12R and 12L. FIG. 12B is a diagram illustrating temporal changes in the received strength of wireless signals at a time when the user UsrA is approaching the left image forming apparatus 12L.

As illustrated in FIG. 12A, when a distance between feature points (e.g., the positions of the wireless communication units 40) of the two image forming apparatuses 12R and 12L is denoted by Dis2, Dis2<Dth2. In this case, while the user UsrA is waiting in front of the image forming apparatus 12L, the mobile terminal 14 is located inside the printing permission areas 110L and 110R.

As a result, as illustrated in FIG. 12B, RSSI>Ith2>Ith1 for both the received strengths IR and IL while the user UsrA is waiting, and the printing permission conditions for the image forming apparatuses 12R and 12L are simultaneously satisfied. That is, the two image forming apparatuses 12R and 12L try to achieve remote login and printing for the user UsrA.

In step S13 illustrated in FIG. 8, therefore, the printing determination section 70 checks whether a printing execution notification has been received from an external apparatus when the printing permission conditions are satisfied in step S12. The printing execution notification is a notification from another image forming apparatus 12 indicating that printing specified by the user UsrA is to be performed. The external apparatus, which transmits the printing execution notification, may be another image forming apparatus 12 connected to the short-range network NW or a higher apparatus (e.g., the information management server 16) that controls printing processes performed by the image forming apparatuses 12.

If the image forming apparatus 12 has not received a printing execution notification (NO in step S13), the process proceeds to step S14. If the image forming apparatus 12 has received a printing execution notification (YES in step S13), the process proceeds to step S17, which will be described later.

In step S14, the notification means 76 receives a notification instruction from the printing control unit 62 and transmits a printing execution notification to another image forming apparatus 12 connected to the short-range network NW. When the notification means 76 is the network communication unit 38, the image forming apparatus 12 transmits a notification message including information necessary to identify a print job to be executed to a specified destination or broadcasts the notification message. The image forming apparatus 12 may transmit the notification message before a start of the corresponding print job, during execution of the corresponding print job, or after an end of the corresponding print job. The image forming apparatus 12 may transmit the notification massage as early as possible in order to avoid overlapping of print jobs.

The image forming apparatus 12 may thus be provided with the notification means 76 that transmits a printing execution notification to another image forming apparatus 12 when the printing control unit 62 requests printing. In this case, the plurality of image forming apparatuses 12 can transmit printing execution notifications to each other, and another notification apparatus for outputting printing execution notifications need not be provided.

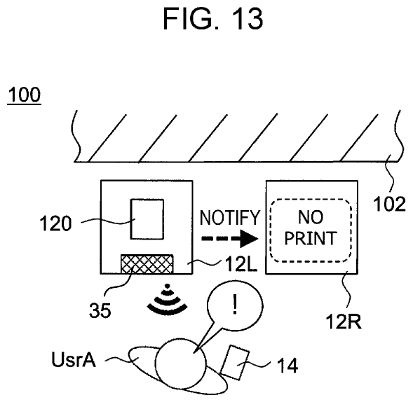

In step S15, the printing control unit 62 (more specifically, the printing instruction section 72) instructs the printing section 44 to perform printing using the print data 48 specified by the user UsrA. The printing section 44 performs printing using the print data 48 to output a desired print 120 (FIG. 13).

In step S16, the information means 74 receives an informing instruction from the printing control unit 62 and informs the user UsrA that the printing requested by the user UsrA has been completed. When the information means 74 is the UI unit 35, for example, a completion message may be displayed on the display or a speaker may output a completion sound. When the information means 74 is the wireless communication unit 40, the wireless communication unit 40 may output a wireless signal including a completion instruction to the mobile terminal 14.

The process returns to step S3 illustrated in FIG. 3. After the remote login by the user UsrA is canceled, the flowcharts of FIGS. 7 and 8 are repeated. If the image forming apparatus 12 has received a printing execution notification in step S13 (YES in step S13), on the other hand, the process proceeds to step S17.

In step S17, the login management unit 60 (more specifically, the remote login processing section 66) refers to the login management table 80 and the print job queue 82 and identifies the user UsrA who has performed remote login. The login management unit 60 removes the login information regarding the user UsrA from the current login management table 80 to cancel the remote login by the user UsrA.

The login management unit 60 may thus cancel the remote login by the user UsrA when a printing execution notification has been received. In this case, unnecessary login by the user UsrA for whom printing has been completed as requested can be suppressed, and a processing load relating to remote login can be reduced compared to when remote login by the user UsrA remains permitted despite reception of a printing execution notification.

In step S18, the printing control unit 62 (more specifically, the printing instruction section 72) stops the printing corresponding to the printing execution notification. More specifically, if a printing instruction has not been issued, the printing instruction section 72 forbids the instruction. If a printing instruction has been issued, the printing instruction section 72 cancels the instruction. The process returns to step S1 illustrated in FIG. 7, and the flowcharts of FIGS. 7 and 8 are repeated.

FIG. 13 is a diagram illustrating an effect produced by a printing execution notification. In the example illustrated in FIG. 13, between the two image forming apparatuses 12R and 12L, the left image forming apparatus 12L performs printing and outputs a print 120. The user UsrA is informed of completion of the printing and obtains the print 120 from the image forming apparatus 12L. Because the right image forming apparatus 12R has received a print execution notification from the image forming apparatus 12L, the image forming apparatus 12R does not output the same print 120. As a result, no resources are wasted by redundant printing and inconvenience in information control due to a leftover print 120 is not caused.

### Summary of Exemplary Embodiment

As described above, the image forming apparatus 12 includes the printing unit 44 that performs printing using the print data 48, the wireless communication unit 40 that transmits and receives a wireless signal based on radio waves or space lighting to and from the mobile terminal 14 associated with the user UsrA, the login management unit 60 that manages a state of remote login by the user UsrA in accordance with a received strength of a wireless signal received by the wireless communication unit 40 or a physical quantity that correlates with the received strength, and the printing control unit 62 that, if a time series of the received strength or a time series of the physical quantity satisfies a predetermined condition during the remote login by the user UsrA, instructs the printing unit 44 to perform printing using the print data 48 specified by the user UsrA and, if the image forming apparatus 12 receives a printing execution notification indicating that another image forming apparatus 12 is to perform printing specified by the user UsrA, forbids an instruction for printing corresponding to the printing execution notification or cancels an instruction for printing that has already been issued.

In a method for forming an image and a non-transitory computer readable medium, the image forming apparatus 12 performs a process including managing a state of remote login by the user UsrA in accordance with the received strength or the physical quantity (S3 and S8), instructing the printing section 44 to perform the printing using the print data 48 specified by the user UsrA (S15), and, if the image forming apparatus 12 receives a printing execution notification, forbidding an instruction for printing corresponding to the printing execution notification or canceling an instruction for printing that has already been issued (S18).

Since, if a printing execution notification is received during remote login by the user UsrA, an instruction for printing corresponding to the printing execution notification is forbidden or an instruction for printing that has already been performed is canceled, the instruction for, or the execution of, the printing performed by the image forming apparatus 12 is stopped even if similar time patterns of signal strength are simultaneously detected from a single mobile terminal 14. As a result, simultaneous printing of the same print 120 by a plurality of image forming apparatuses 12 provided close to one another is suppressed when login by the user UsrA is managed and printing is requested using the received strength of wireless signals successively output from the mobile terminal 14, compared to when a relationship between the image forming apparatuses 12 is not taken into consideration.

In addition, if a received strength is higher than a first threshold (i.e., RSSI>Ith1), the login management unit 60 may permit the user UsrA associated with the mobile terminal 14 to perform remote login. If the received strength is at least higher than a second threshold, which is larger than the first threshold (i.e., RSSI>Ith2>Ith1), the printing control unit 62 may instruct the printing section 44 to perform the printing specified by the user UsrA. In this case, a behavioral characteristic of a user who approaches the image forming apparatus 12 in order to obtain the print 120 is reflected, and printing is performed at a more appropriate timing compared to when the first and second thresholds are the same.

In particular, if the amount of temporal change in the received strength remains lower than a third threshold (i.e., ΔI<ΔIth) for longer than the predetermined period of time Tc, the printing control unit 62 may instruct the printing unit 44 to perform the printing specified by the user UsrA. In this case, a behavioral characteristic of the user who waits around the image forming apparatus 12 before obtaining the print 120 is reflected, and printing is performed at a more appropriate timing compared to when the amount of temporal change in the received strength is not taken into consideration.

In addition, the printing control unit 62 may set, as the second threshold Ith2, a received strength corresponding to a distance (Dth2) shorter than the distance Dis1 from the image forming apparatus 12 to another image forming apparatus 12. In this case, overlapping of the printing permission areas 110R and 110L of the plurality of image forming apparatuses 12 is suppressed, and a possibility that the plurality of image forming apparatuses 12 request printing at substantially the same time is reduced, compared to when a received strength corresponding to a distance longer than the distance Dis1 is set as the threshold Ith2.

In contrast, the printing control unit 62 may set, as the second threshold Ith2, a received strength corresponding to a distance (Dth2) longer than the distance Dis2 from the image forming apparatus 12 to another image forming apparatus 12. In this case, the printing permission areas 110R and 110L of the plurality of image forming apparatuses 12 more deeply overlap, and the anisotropy of the entirety of a covered area tends to be suppressed compared to when a received strength corresponding to a distance shorter than the distance Dis2 is set as the threshold Ith2.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An image forming apparatus comprising:
a printing unit that performs printing using print data;
a wireless communication unit that transmits and receives a wireless signal based on radio waves or space lighting to and from a mobile terminal associated with a user;
a login management unit that manages a state of first login by the user in accordance with a received strength of a wireless signal received by the wireless communication unit or a physical quantity that correlates with the received strength; and
a printing control unit that, if a time series of the received strength or a time series of the physical quantity satisfies a predetermined condition during the first login by the user, instructs the printing unit to perform printing using the print data specified by the user and, if the image forming apparatus receives a printing execution notification indicating that another image forming apparatus is to perform printing specified by the user, forbids an instruction for printing corresponding to the printing execution notification or cancels an instruction for printing that has already been issued.

2. The image forming apparatus according to claim 1,
wherein, if the received strength is higher than a first threshold, the login management unit permits the user associated with the mobile terminal to perform the first login, and
wherein, if the received strength is at least higher than a second threshold, which is larger than the first threshold, the printing control unit instructs the printing unit to perform the printing specified by the user.

3. The image forming apparatus according to claim 2,
wherein, if an amount of temporal change in the received strength remains lower than a third threshold for longer than a predetermined period of time, the printing control unit instructs the printing unit to perform the printing specified by the user.

4. The image forming apparatus according to claim 2,
wherein the printing control unit sets, as the second threshold, a received strength corresponding to a distance shorter than a distance from the image forming apparatus to another image forming apparatus.

5. The image forming apparatus according to claim 3,
wherein the printing control unit sets, as the second threshold, a received strength corresponding to a distance shorter than a distance from the image forming apparatus to another image forming apparatus.

6. The image forming apparatus according to claim 2,
wherein the printing control unit sets, as the second threshold, a received strength corresponding to a distance longer than a distance from the image forming apparatus to another image forming apparatus.

7. The image forming apparatus according to claim 3,
wherein the printing control unit sets, as the second threshold, a received strength corresponding to a distance longer than a distance from the image forming apparatus to another image forming apparatus.

8. The image forming apparatus according to claim 1,
wherein the login management unit cancels the first login by the user when the printing execution notification has been received.

9. The image forming apparatus according to claim 2,
wherein the login management unit cancels the first login by the user when the printing execution notification has been received.

10. The image forming apparatus according to claim 3,
wherein the login management unit cancels the first login by the user when the printing execution notification has been received.

11. The image forming apparatus according to claim 4,
wherein the login management unit cancels the first login by the user when the printing execution notification has been received.

12. The image forming apparatus according to claim 5,
wherein the login management unit cancels the first login by the user when the printing execution notification has been received.

13. The image forming apparatus according to claim 6,
wherein the login management unit cancels the first login by the user when the printing execution notification has been received.

14. The image forming apparatus according to claim 7,
wherein the login management unit cancels the first login by the user when the printing execution notification has been received.

15. The image forming apparatus according to claim 1,
wherein the login management unit manages a state of second login, which is different from the first login, in accordance with a user operation performed using the login operation unit provided for the image forming apparatus and forbids the user from performing the first login during the second login by another user.

16. The image forming apparatus according to claim 2,
wherein the login management unit manages a state of second login, which is different from the first login, in accordance with a user operation performed using the login operation unit provided for the image forming apparatus and forbids the user from performing the first login during the second login by another user.

17. The image forming apparatus according to claim 15,
wherein, when forbidding the user from performing the first login, the wireless communication unit transmits, to the mobile terminal, a wireless signal for informing the user that a printing request from the user will not be accepted.

18. The image forming apparatus according to claim 1, further comprising:
a notification unit that, when the printing control unit instructs the printing unit to perform printing, transmits the printing execution notification to another image forming apparatus.

19. A non-transitory computer readable medium storing a program causing an image forming apparatus including a printing unit that performs printing using print data and a wireless communication unit that transmits and receives a wireless signal based on radio waves or space lighting to and from a mobile terminal associated with a user to execute a process for forming an image, the process comprising:
managing a state of first login by the user in accordance with a received strength of a wireless signal received by the wireless communication unit or a physical quantity that correlates with the received strength;
instructing, if a time series of the received strength or a time series of the physical quantity satisfies a predetermined condition during the first login by the user, the printing unit to perform printing using the print data specified by the user; and
forbidding, if the image forming apparatus receives a printing execution notification indicating that another image forming apparatus is to perform printing specified by the user, an instruction for printing corresponding to the printing execution notification or canceling an instruction for printing that has already been issued.

20. An image forming system comprising:
an image forming apparatus including
a printing unit that performs printing using print data,
a wireless communication unit that transmits and receives a wireless signal based on radio waves or space lighting to and from a mobile terminal associated with a user,
a login management unit that manages a state of first login by the user in accordance with a received strength of a wireless signal received by the wireless communication unit or a physical quantity that correlates with the received strength, and
a printing control unit that, if a time series of the received strength or a time series of the physical quantity satisfies a predetermined condition during the first login by the user, instructs the printing unit to perform printing using the print data specified by the user and, if the image forming apparatus receives a printing execution notification indicating that another image forming apparatus is to perform printing specified by the user, forbids an instruction for printing corresponding to the printing execution notification or cancels an instruction for printing that has already been issued; and
at least one mobile terminal that is carried by the user and that performs wireless communication with the image forming apparatus.
